(19) United States
(12) Patent Application Publication
(10) Pub. No.: US 2008/0205439 A1
(43) Pub. Date: Aug. 28, 2008

(54) METHOD AND DEVICE FOR COMPENSATING FOR DELAYS OF A PLURALITY OF COMMUNICATION CHANNELS

(75) Inventors: Yu Li, Beijing (CN); Guo Hui Lin, Beijing (CN); Wen Bo Shen, Haidian District (CN); Yu Dong Yang, Beijing (CN)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 11/871,825

(22) Filed: Oct. 12, 2007

(30) Foreign Application Priority Data
Oct. 13, 2006 (CN) 200610132278.X

(51) Int. Cl. H04J 3/16

(52) U.S. Cl. 370/465

(57) ABSTRACT

A device and method for compensating for delays of a plurality of communication channels, provides signals with a certain frequency range, wherein the signals form standing waves in the plurality of communication channels; calculates phase differences between the plurality of communication channels according to the signal frequencies at the peak values of the standing waves; and determines the delay of each communication channel according to the above phase differences. The device and method may be applied to the communication channels of high speed parallel connection to eliminate the delays of the communication channels and realize length matching. Since the device and method determine the delays of communication channels by means of the phase differences, even when the delay difference exceeds a clock cycle, it can calculate the phase differences properly.

### TECHNICAL FIELD OF THE INVENTION

The present invention relates to data transmission technology, and specifically to a method and device for measuring and compensating for delays along data transmission communication channels.

### BACKGROUND OF THE INVENTION

For an interconnection between elements such as chips, usually transmission lines are used as communication channels for carrying data. With the increasingly development of the high-performance electronic, computing and networking apparatus, the demand for bandwidth of communication channels is being driven ever higher.

A conventional method of chip interconnection is a parallel connection. In this parallel connection, the interconnection is implemented using a parallel data bus. At the transmission end, parallel data is transmitted together with a clock; while at the receiver end, the received data is sampled according to the received clock signals. As a result, the parallel connection requires that delays of all the transmission lines are within a certain range, i.e. requires that all the transmission lines are the same in length. Therefore, in a PCB design, the designer uses line trace to eliminate the delay differences between a plurality of transmission lines. In this way, not only the complexity of the PCB board layout is increased, but with the signal speed rising, the trace is limited due to the precision of calculation and manufacture.

To overcome the defects of the conventional method of chip interconnection, two substitution methods are provided in the prior art: a high speed serial connection method and an improved parallel connection method.

The high speed serial connection may use a PCI Express bus technology, Rapid 10 technology, Infiniband technology, and so on. Such serial connection method may reach a very high data transmission rate, for example 10 Gb/s. However, the serial connection method also has the following problems: firstly the structure of the circuit for serial transmission is relatively complicated, and due to the existence of clock data recovery circuits, the power consumption of the serial connection circuit is very high, thereby resulting in a higher cost. Secondly, in order to distill the clock information from the data signals, it is necessary to add a redundant clock pattern into the signal code. In an 8B/10B encode mode, it will cost 20% of the bandwidth. Thirdly, multiple serial connections needs a complicated mechanism for aligning the data phases between the respective serial channels, thereby resulting in a complicated initial protocol and circuit design.

An improved parallel connection method uses Flex IO technology which is a high speed connection method used by the Rambus Corporation. This method conducts delay calculation with phase detect circuits. Although the method declares it can reach 2.5 ps resolution in the delay network, it cannot ensure the accuracy of the phase detect circuits to reach 2.5 ps as well. Moreover, if the delay difference exceeds a clock period, the phase cannot be detected properly with this method. In addition, the circuit using this method is more complicated and the data transmission rate and the lengths of the transmission lines are both limited by the structure.

The US patent publication 2005/0234669, entitled “Method and Apparatus for Calibrating Communications Channels” provides a method which adjusts the delay of each transmission line by calculating the lengths of the transmission lines or transmission delays of the transmission lines, thereby calibrating a plurality of communication channels. Specifically, zero value and peak value of the envelope of the standing wave on each communication channel are detected and then the lengths of the transmission lines or transmission delays are calculated according to the signal frequencies at the zero value or the peak value. However, since this method measures the absolute lengths of the respective channels, it is required to know parameters such as a dielectric constant of the dielectric and the like.

### SUMMARY OF THE INVENTION

The present invention is directed to the above technical problem, and its objective is to provide a method and device of compensating for delays of a plurality of communication channels based on standing waves, which may be applied to the communication channels of high speed parallel connection and may deal with the problem that the delay difference exceeds a clock cycle. The structure thereof is simple and the power consumption is low.

According to one aspect of the present invention, there is provided a method for compensating for delays of a plurality of communication channels, comprising the following steps of:

providing signals with a certain frequency range, wherein the signals form standing waves in the plurality of communication channels;

calculating phase differences between the plurality of communication channels according to the signal frequencies at the peak values of the standing waves; and

determining the delay of each communication channel according to the above phase differences.

According to another aspect of the present invention, there is provided a device for compensating for delays of a plurality of communication channels, comprising:

a signal generator for generating signals with a certain frequency range and providing them to the plurality of communication channels, wherein the signals form standing waves in the plurality of communication channels; and

a controller for calculating phase differences between each of the plurality of communication channels according to the signal frequencies at the peak values of the standing waves and determining the delay of each communication channel according to the above phase differences.

### DESCRIPTION OF THE DRAWINGS

FIG. 1 is a flowchart of a method for compensating for delays of a plurality of communication channels according to an embodiment of the present invention;

FIG. 2 is a block diagram of a device for compensating for delays of a plurality of communication channels according to an embodiment of the present invention;

FIG. 3 is a schematic diagram of one example of a voltage control oscillator in the device for compensating for delays of a plurality of communication channels as shown in FIG. 2;

FIG. 4 is a schematic diagram of one example of an envelope detector in the device for compensating for delays of a plurality of communication channels as shown in FIG. 2;

FIG. 5 is a schematic block diagram of one example of a peak value detector in the device for compensating for delays of a plurality of communication channels as shown in FIG. 2;

FIG. 6 is a schematic diagram of one example of a zero crossing detector in the peak value detector as shown in FIG. 5;

FIG. 7 is a schematic block diagram of one example of a controller in the device for compensating for delays of a plurality of communication channels as shown in FIG. 2;

FIG. 8 is a schematic diagram of one example of the controller; and

FIG. 9 is a schematic diagram of one example of a delay circuit in the device for compensating for delays of a plurality of communication channels as shown in FIG. 2.

### DETAILED DESCRIPTION OF THE INVENTION

It is believed that the above and other objectives, features and advantages of the present invention will become more apparent through the following detailed description of the embodiments of the present invention with the accompanying drawings.

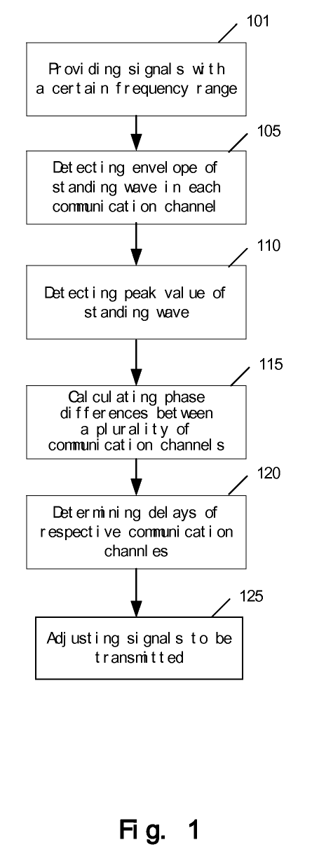

FIG. 1 is a flowchart of a method for compensating for delays of a plurality of communication channels according to an embodiment of the present invention.

According to the principle of standing wave, standing wave detection may be used for determining the lengths of transmission lines of communication channels and the corresponding transmission delays. Since the standing waves with different amplitudes are caused by the transmission lines with different lengths, the lengths of the transmission lines may be calculated and the delays of transmission lines may be determined by detecting the amplitudes of the standing waves at different frequencies, so that the transmitting signals at the transmission lines may be adjusted to receive aligned signals at the receiving end. The embodiments of the present invention are based on the above principle of standing waves and make a further improvement on this basis: instead of obtaining the absolute lengths of the transmission lines to accordingly determine the delays of the transmission lines in the embodiments of the present invention, the present invention obtains phase differences between the transmission lines generated by transmitting signals at a particular frequency in the respective transmission lines according to the relative lengths between the transmission lines to accordingly determine the delays of the transmission lines.

As shown in FIG. 1, firstly, at Step 101, signals with a frequency range are provided, which form standing waves in a plurality of communication channels. Generally, standing waves are produced as the result of the repeated interference of two waves at identical frequency while moving in opposite directions along the same medium. There are wave nodes and wave anti-nodes in a standing wave. The wave nodes are points of no displacement (minimal amplitude) caused by the destructive interference of the two waves, and the wave anti-nodes are points of maximal displacement (maximal amplitude) caused by the constructive interference of the two waves.

In this embodiment, the forming of the standing waves in the communication channels may be achieved by configuring the receiving ends of the communication channels as high impedance. In this case, since the receiving end of the communication channels is open, the transmitted signals are all reflected to the transmitting end so as to form the standing waves in the communication channels.

In this embodiment, in order to provide signals with a certain frequency range, it is required to determine the frequency range of the signals at first. And then, the signals are provided by scanning the entire frequency range starting from the initial frequency so that the signals are varied throughout the entire frequency range starting from the initial frequency. This method is only exemplary, and it would be apparent for persons having ordinary skills in the art to employ other methods for providing signals with a certain frequency range.

Next, at Step 105, the envelope of the standing wave in each communication channel is detected at the transmitting end of the communication channel. Multiple methods for detecting envelopes in the prior art are known for persons having ordinary skills in the art, and thus will not be described in details herein.

Then, at Step 110, a peak value of the standing wave in each communication channel is detected according to the detected envelope. Specifically, in this embodiment, the envelope of the standing wave is differentiated and then zero crossing detection is performed, i.e. the point where the value of the differentiated envelope equals to zero is detected. So this point corresponds to the peak value of the standing wave. Of course, other methods for detecting peak value are known and may be employed by persons having ordinary skills in the art.

At Step 115, according to the signal frequency at the peak value of the standing wave in each communication channel, phase differences between a plurality of communication channels corresponding to the signal frequency may be calculated.

The phase differences between a plurality of communication channels are illustrated as follows using two communication channels as an example.

In the assumption that an incident wave and a reflected wave forming a standing wave have the same phase at the origin and the start point and the end point are the wave nodes or wave anti-nodes, the combined amplitude of the incident wave and the reflected wave is:

$$A = 2 {A}_{1} cos \frac{2 π}{λ} x \qquad ( 1 )$$

wherein, A₁ is the amplitude of the incident wave and the reflected wave, x is the distance from the origin, and Λ is the wavelength of the standing wave. As a result, it can be deduced from the formula (1) that when x=k/2λ, the amplitude is maximum, x is the wave anti-node, wherein k is an integer.

Supposing there are two communication channels, whose lengths are L₁ and L₂ respectively; and L₂>L₁ is satisfied.

For the communication channel L₁, if the standing wave is formed with the frequencies f₁ and f₂, then:

$$\begin{matrix}{L}_{1} = \frac{{k}_{1}}{2} {λ}_{1} = \frac{( {k}_{1} + 1 )}{2} {λ}_{2} \\ and & ( 2 ) \\ {λ}_{1} {f}_{1} = \frac{c}{ɛ} = a = {λ}_{2} {f}_{2} & ( 3 )\end{matrix}$$

wherein c denotes the optical speed, ∈ is a dielectric constant of the dielectric, and a is a constant.

According to the formulas (2) and (3), it can be obtained that

$${L}_{1} = \frac{{k}_{1}}{2} \cdot \frac{a}{{f}_{1}} = \frac{( {k}_{1} + 1 )}{2} \cdot \frac{a}{{f}_{2}} ,$$

thus it can be deduced that

$${L}_{1} = \frac{a}{2 {f}_{1}} \cdot \frac{{f}_{1}}{{f}_{2} - {f}_{1}} = \frac{a}{2 ( {f}_{2} - {f}_{1} )} .$$

In a similar way, for the communication channel L₂, if the standing wave is formed with the frequencies f₃ and f₄, then

$${L}_{2} = \frac{a}{2 ( {f}_{4} - {f}_{3} )} .$$

Thus, the phase difference of the communication channel L₂ relative to L₁ is:

$$( \frac{{L}_{2} - {L}_{1}}{{λ}_{1}} ) \cdot 2 π = π {f}_{1} ( \frac{1}{{f}_{4} - {f}_{3}} - \frac{1}{{f}_{2} - {f}_{1}} ) . \qquad ( 4 )$$

It can be seen from the above description that the phase differences between the communication channels are dependant on the frequencies at the peak values of the standing waves in the respective communication channels.

As a result, in this embodiment, in order to calculate the phase differences between a plurality of communication channels, for each communication channel, the signal frequencies at two peak values of the standing wave in the communication channel is recorded firstly. Then the phase differences between the plurality of communication channels are calculated according to the formula (4).

Next, at Step 120, the delays of the respective communication channels are determined according to the calculated phase differences. Specifically, the phase difference is multiplied by the frequency of the corresponding transmitted signal and the obtained product is the delay of the communication channel.

Finally, at Step 125, the signals to be transmitted in the corresponding communication channels are adjusted according to the obtained delays of the communication channels. Specifically, the signals to be transmitted in the respective communication channels are added into the pre-delay signals corresponding to the delays of the corresponding communication channels, so that the arriving time of the signals at the receiving ends after the transmission through the respective communication channels with unequal lengths is the same.

It can be seen from the above description that the method for compensating for delays of a plurality of communication channels based on standing waves in this embodiment may be applied to the communication channels of high speed parallel connection to eliminate the delays of the communication channels and accomplish length matching. Moreover, since the method of this embodiment determines the delays of the communication channels by means of the phase differences, even in the situation that the delay difference exceeds a clock cycle, it can calculate the phase differences properly. Besides, in comparison with the parallel connection method using the Flex IO technology in the prior art, the frequency is easier to measure relative to the phase and thus it has a higher precision. In addition, the method of this embodiment is unnecessary to obtain the absolute lengths of the communication channels, thus is also unnecessary to know the dielectric constants of the communication channels.

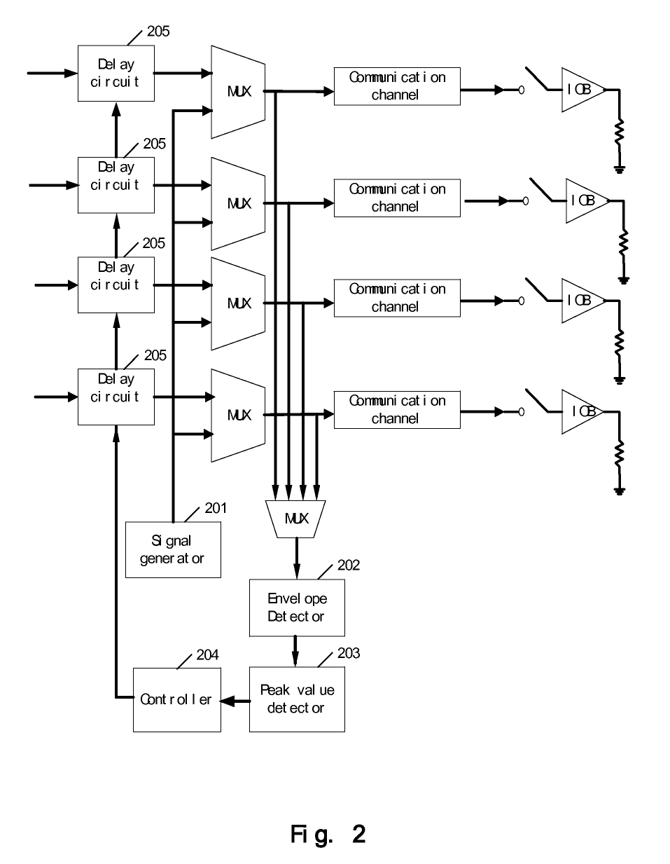

A device for compensating for delays of a plurality of communication channels according to an embodiment of the present invention is described in details hereinbelow according to FIGS. 2 to 9.

FIG. 2 is an overall block diagram of a device for compensating for delays of a plurality of communication channels according to an embodiment of the present invention.

As shown in FIG. 2, the device for compensating for delays of a plurality of communication channels according to this embodiment is positioned at the transmitting ends of the plurality of communication channels, comprising: a signal generator 201 for generating signals with a certain frequency range and providing them to the plurality of communication channels, the signals forming standing waves in the respective communication channels; an envelope detector 202 with one end connected to the transmitting ends of the plurality of communication channels for detecting envelopes of the standing waves in the respective communication channels; a peak value detector 203 with the input end connected to the output end of the envelope detector 202 for detecting peak values of the standing waves; a controller 204 for, according to the signal frequencies at the peak values of the detected standing waves, calculating phase differences between the plurality of communication channels corresponding to the signal frequencies, and determining the delay of each communication channel according to the calculated phase differences; and a plurality of delay circuits 205 for adjusting the signals to be transmitted in the respective communication channels according to the delay of each communication channel.

In this embodiment, a plurality of communication channels share the signal generator 201, the envelope detector 202, the peak value detector 203, and the controller 204, and thus it also comprises a plurality of multiplexer MUX, positioned between the delay circuit 205 and the transmitting ends of the communication channels and between the transmitting ends of the plurality of communication channels and the envelope detector 202, for switching between the normal signal path and the device for compensating for delays of a plurality of communication channels based on standing wave in this embodiment and selecting communication channels. For the multiplexer MUX, it is known for persons having ordinary skill in the art and will not be described in details herein.

The operation process and principle of the device for compensating for delays of a plurality of communication channels in this embodiment are further described hereinbelow.

At first, the signal generator 201 generates the signals with a certain frequency range. The initial frequency and frequency range of signals may be pre-determined. The signal generator 201 may generate the signals variable in frequency by scanning the pre-determined entire frequency range starting from the initial frequency.

Preferably, the signal generator 201 may be a voltage control oscillator (VCO). In this case, the voltage control oscillator generates signals with the frequency varying from low to high (or from high to low) according to the control signals, i.e. control voltages, generated by the controller 204, wherein the frequency is corresponding to the control voltage.

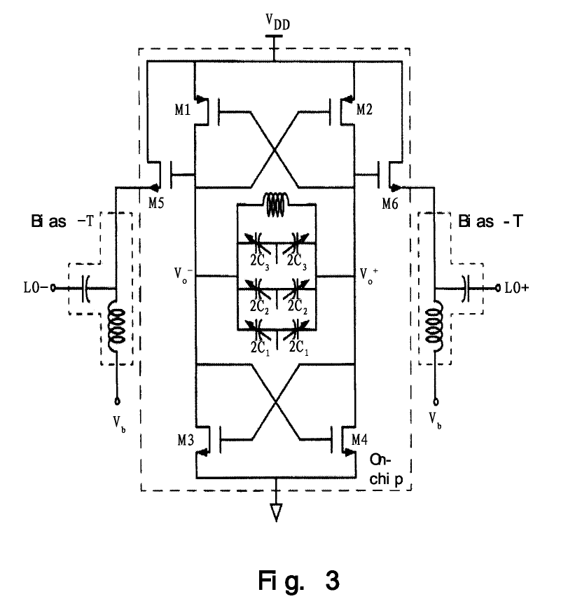

The voltage control oscillator is well-known for persons having ordinary skills in the art. FIG. 3 shows a schematic diagram of an example of a voltage control oscillator which achieves a wide tune threshold through different capacitor networks. As shown in FIG. 3, the voltage control oscillator is a LC cross-coupling difference VCO having pMOS and nMOS delays. The delays generate negative impedance to eliminate the loss in the LC resonator. The LC resonator includes a single ring U-shaped inductor and an AMOS variable capacitance diode, wherein the nominal capacitances of C1 and C2 are relatively small and equal, and the nominal capacitance of C3 is relatively large. Due to the particular character of the AMOS variable capacitance diode, all the variable capacitance diodes are used as digital switches or as continuous adjustable variable capacitance diodes. Source followers M5 and M6 are used for buffering outputs. The current sources of the source followers are replaced with external bias-T to provide high AC impedance. The details of the voltage control oscillator may be referenced to the paper “Design of Wide-Band CMOS VCO for Multiband Wireless LAN Applications”, N. Fong, et al, IEEE JOURNAL OF SOLID-STATE CIRCUITS, VOL. 38, NO. 8, AUGUST, 2003, p. 1333-1342. Of course, persons having ordinary skills in the art may use other voltage control oscillators.

Next, the generated signals with variable frequency are provided to a plurality of communication channels. The signals may form the standing waves in the respective communication channels by configuring the receiving ends of the respective communication channels as high impedance. After the standing waves are formed, the envelope detector 202 detects the envelopes of the standing waves and provides the detected envelopes to the peak value detector 203.

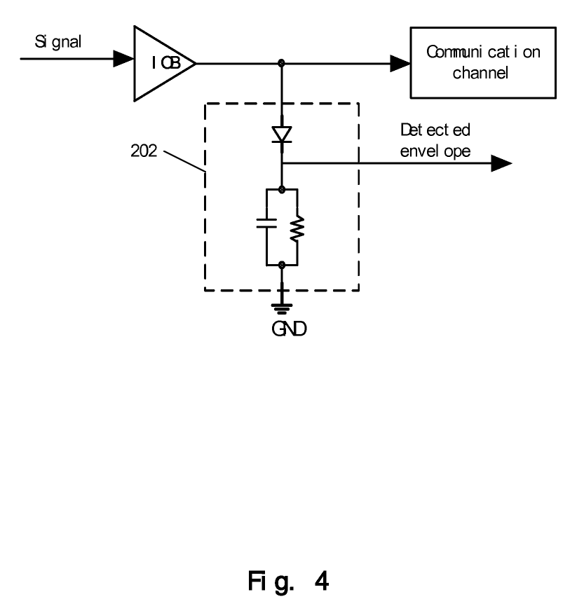

An example of the envelope detector 202 is shown in FIG. 4. The envelope detector 202 is a diode envelope detector consisting of a diode and a LC filter circuit. The envelope detector 202 realizes the envelope detection by using the unidirectional conductivity of the diode and the LC charging and discharging process. The detected envelope is outputted from the negative end of the diode.

Of course, for greater sensitivity, more complicated circuits may be used to implement the envelope detector 202.

The envelopes outputted from the envelope detector 202 are inputted to the peak value detector 203 to detect the peak values of the standing waves. FIG. 5 shows a schematic diagram of a peak value detector 203. After the peak value detector 203 receives the envelopes of the standing waves, it differentiates the inputted envelopes of the standing waves through a differentiator 2031 and outputs the results into the zero crossing detector 2032. And then, the zero crossing detector 2032 detects the points where the values of the differentiated envelopes are equal to zero. As a result, the obtained points correspond to the peak values of the inputted standing waves. In fact, the output signals of the peak value detector 203 are zero impulses, i.e. upon the zero crossing detector 2032 detecting a zero, an impulse signal is outputted.

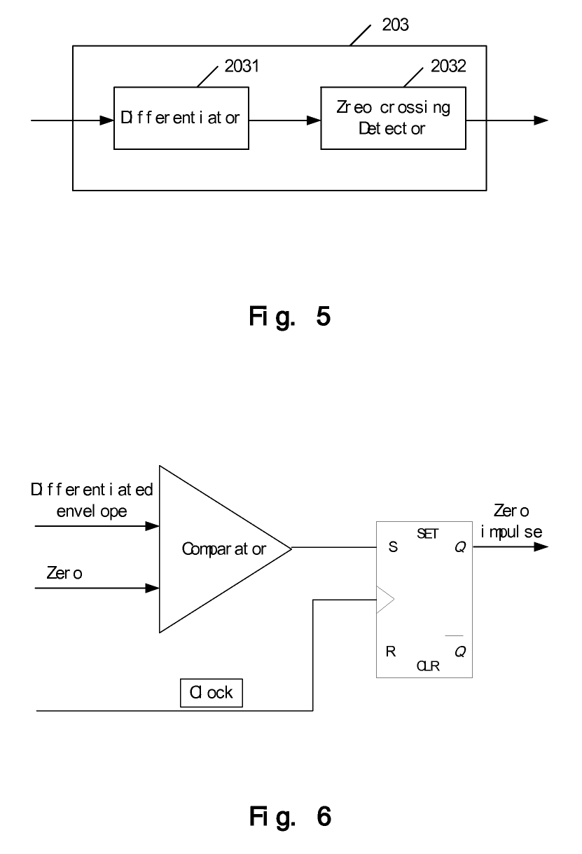

FIG. 6 gives a schematic diagram of an example of a zero crossing detector 2032 which includes a comparator and a R-S trigger. The differentiated envelopes outputted from the differentiator 2031 are inputted to one input end of the comparator and the input of another input end is zero. The comparison result is outputted to an S end of the R-S trigger and a zero impulse is outputted after passing through the R-S trigger. Of course, it is apparent for persons having ordinary skills in the art that other zero crossing detectors may be employed.

The zero impulse signals representing the peak values of the standing waves are inputted into the controller 204. The controller 204 calculates the phase differences between a plurality of communication channels and determines the delay of each communication channel according to the phase differences.

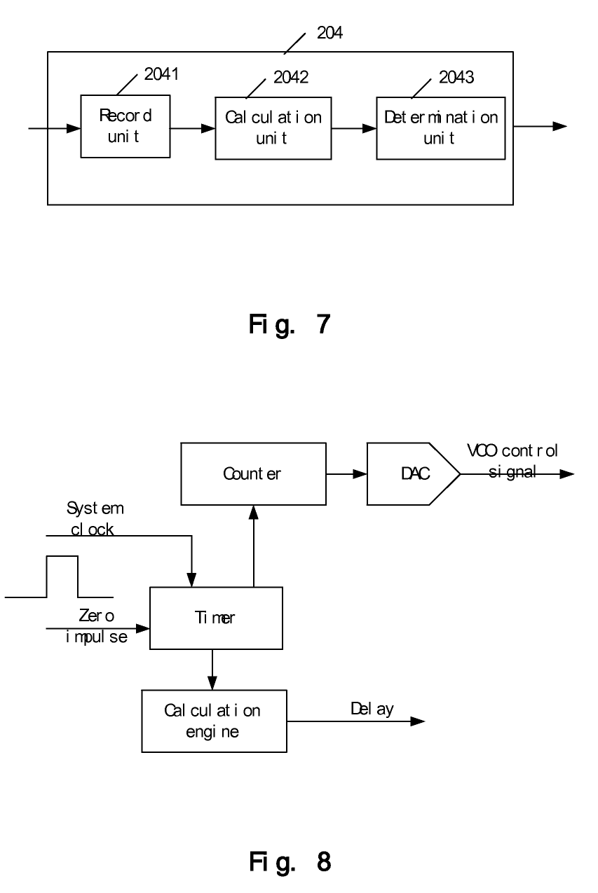

FIG. 7 is a block diagram showing the exemplary structure of the controller 204. As shown in the figure, the controller 204 comprises a record unit 2041, a calculation unit 2042, and a determination unit 2043. As stated in the above, the phase differences between the communication channels are dependant on the frequencies at the peak values of the standing waves in the respective communication channels. In the controller 204, after a zero impulse signal is inputted to the record unit 2041, the record unit 2041 records the signal frequency at the peak value of the standing wave represented by the zero impulse signal. For each communication channel, the record unit 2041 records the signal frequencies at two peak values. After the signal frequencies at the peak values of the standing waves in all of the communication channels are recorded, the calculation unit 2042 starts to calculate the phase differences between the plurality of communication channels and outputs the results to the determination unit 2043. Specifically, the calculation unit 2042 calculates the phase differences between the plurality of communication channels according to the above-mentioned formula (4). The determination unit 2043 determines the delay of each communication channel according to the calculated phase differences. Specifically, the phase differences are multiplied by the signal frequencies corresponding to the respective communication channels and the obtained product is the delays of the communication channels.

FIG. 8 shows an example of the specific implementation of the controller 204, wherein a timer is used as the record unit 2041 and a calculation engine is used as the calculation unit 2042 and the determination unit 2043. In case that the signal generator 201 is a voltage control oscillator, the controller also comprises a counter and a digital-to-analog converter DAC for generating signals controlling the voltage control oscillator. After the device for compensating for delays of a plurality of communication channels based on standing waves in this embodiment is actuated, the timer starts to count the clock impulses and outputs it to the counter and the digital-to-analog converter DAC to generate the control signals of the voltage control oscillator. After the standing waves are formed, the zero impulse signals outputted by the zero crossing detector 2032 in the peak value detector 203 are inputted into the timer of the controller and the timer records the time value at this point. Since the signal frequencies are varied with time, the signal frequencies are recorded equivalently. Thereafter, the signal frequencies are inputted into the calculation engine to calculate the phase differences between the plurality of the communication channels and the delay of each communication channel is determined according to the phase differences.

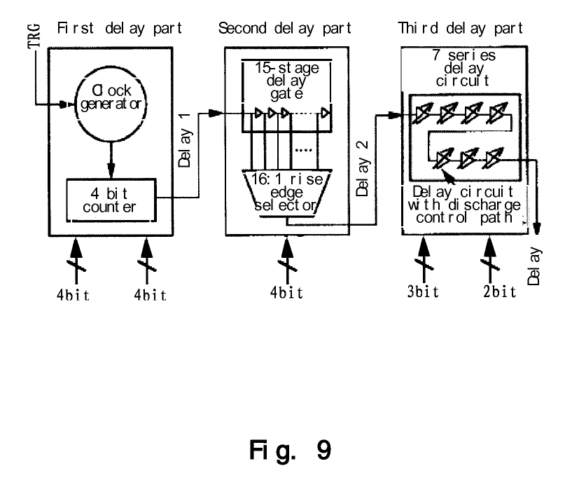

The delay of each communication channel is outputted into the corresponding delay circuit 205 for adjusting the signals to be transmitted in the respective communication channels. FIG. 9 is a schematic diagram showing an example of the delay circuit 205. The delay circuit comprises a first delay part, a second delay part, and a third delay part, wherein the first delay part, the second delay part, and the third delay part have different resolutions. The delay circuit determines the overall delay by using gate propagation delays. The details of the delay circuit may be referenced to a paper “A 12-ps-Resolution Digital Variable-Delay Macro Cell on GaAs 100 K-Gates Gate Array Using a Meshed Air Bridge Structure”, A. Ohta, et al, IEEE JOURNAL OF SOLID-STATE CIRCUITS, VOL. 34, NO. 1, JANUARY 1999. Of course, it is apparent for persons having ordinary skills in the art that other delay circuits may be employed.

In the case of selecting normal signal channels, i.e. configuring the receiving end of the communication channel as normal, the arrival time of the signals having been adjusted by the delay circuits 205 at the receiving ends is the same.

In addition, each of the communication channels may be configured with the envelope detector 202 and the peak value detector 203. In this case, the multiplexer MUX disposed between the transmitting ends of the communication channels and the envelope detector 202 may be unnecessary.

The device for compensating for delays of a plurality of communication channels based on standing wave in this embodiment and the components thereof may be implemented by, for example, super large scale integrated circuit or gate array, semiconductor such as logic chip or transistor, or hardware circuit of programmable hardware apparatus such as field programmable gate array, programmable logic apparatus, and so on, and by software executed by various types of processors, also by the combination of the above hardware circuit and software.

It can be seen from the above description that the device for compensating for delays of a plurality of communication channels based on standing wave in this embodiment may be applied to the communication channels of high speed parallel connections to eliminate the delays of the communication channels and realize length matching. Moreover, as the frequency is easier to measure relative to the phase, the device of this embodiment has a higher precision. In addition, the device of this embodiment may be implemented by simpler components in the prior art, thereby reducing the cost.

Although the method and device for compensating for delays of a plurality of communication channels based on standing wave in the present invention are described in detail with the embodiments in the above description, it should be understood for persons skilled in the art that various modification may be made to the above embodiments without departing from the spirit and the scope of the present invention.

1. A method for compensating for delays in a plurality of communication channels, comprising the steps of:
providing signals with a certain frequency range, wherein the signals form standing waves in the plurality of communication channels;
calculating phase differences between the plurality of communication channels according to signal frequencies at peak values of the standing waves; and
determining delay of each communication channel according to the calculated phase differences.

2. The method of claim 1, further comprising: adding pre-delay signals corresponding to the delays of the respective communication channels into the signals to be transmitted in the respective communication channels, so that signals at the receiving ends after the transmission through the respective communication channels have a same arrival time.

3. The method of claim 1, further comprising:
detecting envelopes of the standing waves at the respective transmitting ends of the plurality of communication channels; and
detecting peak values of the standing waves according to the envelopes.

4. The method of claim 1, further comprising, prior to the step of providing signals: configuring a receiving end of each one of the plurality of communication channels as high impedance.

5. The method of claim 1, wherein the step of providing comprises: determining a frequency range of signals to provide the signals in a manner of scanning an entire frequency range starting from an initial frequency.

6. The method of claim 3, wherein the step of detecting peak values of standing waves comprises: differentiating envelopes of the standing waves, and detecting points where values of the differentiated envelopes equal zero, wherein the points correspond to the peak values of the standing waves.

7. The method of claim 1, wherein the step of calculating comprises: for each communication channel, recording signal frequencies at two peak values of the standing waves; calculating a phase differences between the plurality of communication channels as
$$π {f}_{1} ( \frac{1}{{f}_{4} - {f}_{3}} - \frac{1}{{f}_{2} - {f}_{1}} ) ,$$
as wherein f₁ and f₂ are signal frequencies at the peak values of the standing wave in one communication channel; and f₃ and f₄ are signal frequencies at the peak values of the standing wave in another communication channel.

8. A device for compensating for delays of a plurality of communication channels, comprising.
a signal generator for generating signals with a certain frequency range and providing them to the plurality of communication channels, wherein the signals form standing waves in the plurality of communication channels; and
a controller for calculating phase differences between the plurality of communication channels according to signal frequencies at peak values of the standing waves and determining delay of each communication channel according to the calculated phase differences.

9. The device of claim 8, further comprising: a plurality of delay circuits for adding pre-delay signals corresponding to the delays of the respective communication channels into the signals to be transmitted in the respective communication channels, so that signals at receiving ends arrive at the same time after the transmission through the respective communication channels.

10. The device of claim, further comprising:
at least one envelope detector with one end connected to the transmitting ends of the plurality of communication channels, for detecting envelopes of the standing waves; and
at least one peak value detector for detecting peak values of the standing waves according to the envelopes.

11. The device of claim 8, wherein the signal generator is a voltage control oscillator and the controller is further used for generating control signals of the voltage control oscillator.

12. The device of claim 10, wherein the peak value detector comprises:
a differentiator for differentiating envelopes of the standing waves; and
a zero crossing detector for detecting points where values of the differentiated envelopes equal to zero, wherein the points correspond to the peak values of the standing waves.

13. The device of claim 8, wherein the controller comprises:
a record unit for recording signal frequencies at two peak values of the standing wave in each communication channel;
a calculation unit for calculating phase differences between the plurality of communication channels according to the signals frequencies; and
a determination unit for determining the delay of each communication channel according to the phase differences.

14. The device of claim 13, wherein the calculation unit calculates the phase differences between the plurality of communication channels as
$$π {f}_{1} ( \frac{1}{{f}_{4} - {f}_{3}} - \frac{1}{{f}_{2} - {f}_{1}} ) ,$$
wherein f₁ and f₂ are the signal frequencies at the peak values of the standing wave in one communication channel; f₃ and f₄ are the signal frequencies at the peak values of the standing wave in another communication channel.

15. A program storage device readable by machine storing a program of instructions for performing a method for compensating for delays in a plurality of communication channels, the method comprising the steps of:
receiving signals with a certain frequency range, wherein the signals form standing waves in the plurality of communication channels;
calculating phase differences between the plurality of communication channels according to signal frequencies at peak values of the standing waves; and
determining delay of each communication channel according to the calculated phase differences,
wherein the device calculates the phase differences between the plurality of communication channels as
$$π {f}_{1} ( \frac{1}{{f}_{4} - {f}_{3}} - \frac{1}{{f}_{2} - {f}_{1}} ) ,$$
wherein f₁ and f₂ are the signal frequencies at the peak values of the standing wave in one communication channel; f₃ and f₄ are the signal frequencies at the peak values of the standing wave in another communication channel.
